(19) United States
(12) Patent Application Publication
(10) Pub. No.: US 2024/0430607 A1
(43) Pub. Date: Dec. 26, 2024

(54) Acoustic Earring

(71) Applicant: Yuanhao Liu, Shenzhen (CN)

(72) Inventor: Yuanhao Liu, Shenzhen (CN)

(21) Appl. No.: 18/241,899

(22) Filed: Sep. 4, 2023

(30) Foreign Application Priority Data
Jun. 20, 2023 (CN) 2023107372201

(51) Int. Cl. H04R 1/10; H04R 1/06; H04R 25/02

(52) U.S. Cl. CPC H04R 1/105; H04R 1/06; H04R 1/1016; H04R 1/1091; H04R 25/02; H04R 2201/10; H04R 2420/07

(57) ABSTRACT

An acoustic earring includes an ear-hanging acoustic effect portion for being located at an inner side of a user's antitragus to generate sound effect, an earlobe-surrounding connecting earring portion, and an ear back fitting portion, the earlobe-surrounding connecting earring portion is connected between the ear-hanging acoustic effect portion and the ear back fitting portion.

### CROSS REFERENCE OF RELATED APPLICATION

This application is a non-provisional application that claims priority under 35 U.S.C. § 119 to China application number CN202310737220.1, filing date Jun. 20, 2023, wherein the entire content of which is expressly incorporated herein by reference.

### BACKGROUND OF THE PRESENT INVENTION

### Field of Invention

The present invention relates to an earring, and more particularly to an acoustic earring.

### Description of Related Arts

The smart wearable technology is changing our way of life, with the most notable example being earphones. With the development of Bluetooth technology, people have become increasingly reliant on earphones, not only because they transmit sound, but also because they empower the wearer with independence and the ability to create subjective reality. More importantly, as the boundaries between work and social life blur, earphones have become important modern mediators between public and private spaces.

In recent years, the wireless earphone market has been booming, with products iterating at a very fast pace. With the gradual elimination of the 3.5 mm earphone jack on smartphones that are compatible with the earphones, it further expands the consumer market for Bluetooth earphones.

Conventional earphones usually adopt wearing methods such as in-ear, head-mounted, and neck-hanging. The conventional earphones have the following disadvantages.

Conventional wired earphones have certain constraints in the process of use and are not easy to store; the manufacturing cost of conventional headset earphones is high, and there are many manufacturing processes, it also causes discomfort to users when clamped on the head during wearing and are not conducive to heat dissipation; conventional neck-hanging earphones have a burden feeling when wearing, which is easy to be lost and may cause feeling of unhygienic; conventional behind-the-ear earphones are easy to compete for wearing space with glasses temples already worn by users, and are not easy to store, and the sound quality effect is poor; conventional in-ear earphones cause closure of the user's ear canal during wearing, long-term wearing can may result in hearing disorder, and easily cause bacteria breeding in the user's ear canal, and thus resulting in unhygienic phenomena. In addition, long-term wearing can cause discomfort and pain in the user's ears, and the conventional earphones are not easy to fix, easy to be lost, and not suitable for high fidelity, etc.

### SUMMARY OF THE PRESENT INVENTION

The invention is advantageous in that it provides an acoustic earring which is an earphone hung in the user's cavum conchae through an open wearing method, causing no pain to the user after wearing and improving the sanitary environment inside the user's cavum conchae.

Another advantage of the present invention is to provide an acoustic earring, wherein the acoustic earring is not directly inserted into the user's ear canal to result in compression and pressure on the user's ear canal, thus preventing damage to the user's eardrum or avoiding hearing impairment.

Another advantage of the present invention is to provide an acoustic earring which is suitable to be hung in the user's cavum conchae and is positioned at an appropriate location for sound output without affecting the listening effect or causing sound leakage, so that people nearby cannot hear the sound from the earphone, thus not affecting others and ensuring privacy.

Another advantage of the present invention is to provide an acoustic earring which has a certain decorative function at the user's earlobe when being worn, so as to combine the functions of both an earphone and an earring.

Another advantage of the present invention is to provide an acoustic earring which can be decorated with processes such as diamond inlaying, patterning, and carving on the outer surface of the earphone, making the earphone more decorative.

Another advantage of the present invention is to provide an acoustic earring which can be produced using different manufacturing processes for providing different shapes and configurations of the acoustic earring, allowing for customized production and manufacturing with a high level of user preference and a large target market, making it easy to promote.

Another advantage of the present invention is to provide an acoustic earring, wherein the acoustic earring is manufactured using a highly deformable material, and the relative position between two main parts is adjustable, so that the acoustic earring can be suitable for users of different age groups, suitable for wearing on the ears of different users, not easy to be lost, and suitable for a larger user population.

Another advantage of the present invention is to provide an acoustic earring, wherein the acoustic earring, compared to conventional earphones, disperses the originally centralized sound output system, and in the manufacturing process, the acoustic component located adjacent to the cavum conchae during wearing can be manufactured with a larger size, so as to enhance the sound output performance.

Another advantage of the present invention is to provide an acoustic earring, wherein the acoustic earring has an artificial intelligent interaction function, and can be an access point of the internet of things combining functions of voice reminder and voice wake-up, the acoustic earring, which is incorporated with the artificial intelligence, can obtain voice instructions in real time, recognize and process collected information, provide feedback operation based on semantic results, and finally performing corresponding tasks such as measuring body temperature and checking heart rate.

Another advantage of the present invention is to provide an acoustic earring, wherein the acoustic earring has the function of improving mood and can be set to play music according to the user wearing scene, and then adjusting or improving the user's mood state.

Another advantage of the present invention is to provide an acoustic earring, wherein the acoustic earring can have the function of a hearing-aid, and can be suitable for special groups of people. The earphone and the hearing-aid are combined with each other, and can assist in listening to others while making or receiving phone calls. In this case, free switching is possible, avoiding the trouble caused by replacing the earphone and the hearing-aid instrument, and facilitating the wearing for people with poor hearing.

Another advantage of the present invention is to provide an acoustic earring, wherein the acoustic earring has a wire groove in terms of structure, when the circuit is routed from one side to the other side, the wires in the wire groove can be exposed and displayed with a predetermined color, so as to provide a certain decorative function.

Another advantage of the present invention is to provide an acoustic earring, wherein the acoustic earring, through a split manufacturing process, achieves power supply being arranged at a back side of the user's earlobe, so that the acoustic earring, compared to conventional wireless earphones, can be designed with a larger battery life and can be used for a longer period of time.

According to one aspect of the present invention, the present invention provides n acoustic earring, comprising an ear-hanging acoustic effect portion for being located at an inner side of a user's antitragus to generate sound effect, an earlobe-surrounding connecting earring portion and an ear back fitting portion, the earlobe-surrounding connecting earring portion is connected between the ear-hanging acoustic effect portion and the ear back fitting portion.

According to an embodiment, when the acoustic earring is in a wearing state, the ear-hanging acoustic effect portion is located inside the user's cavum conchae, and the earlobe-surrounding connecting earring portion is extended from a front side of the user's earlobe to a back side of the user's earlobe to position and locate the ear back fitting portion at a back side of the user's earlobe.

According to an embodiment, the ear-hanging acoustic effect portion comprises a first installation element and a first cover body, and has a storage cavity, wherein the first installation element is integrally connected to the earlobe-surrounding connecting earring portion, and the first cover body is installed at a rear side of the first installation element, wherein the storage cavity is located between the first installation element and the second cover body.

According to an embodiment, the ear back fitting portion comprises a second installation element, a second cover body, and has an installation cavity, wherein the second installation element is integrally connected to the earlobe-surrounding connecting earring portion, the second cover body is installed on a rear side of the second installation element, and the installation cavity is located between the second installation element and the second cover body.

According to an embodiment, the earlobe-surrounding connecting earring portion, the first installation element, and the second installation element are integrated and made of same material.

According to an embodiment, the ear-hanging acoustic effect portion comprises a speaker installed in the storage cavity and has a plurality of noise reduction holes formed in the first cover body.

According to an embodiment, the ear back fitting portion comprises a circuit board and a power supply, wherein the circuit board and the power supply are installed in the installation cavity, and the circuit board and the power supply are electrically connected to each other.

According to an embodiment, the earlobe-surrounding connecting earring portion comprises an earlobe front attaching portion and an earlobe back attaching portion integrally connected to the earlobe front attaching portion, wherein when the acoustic earring is in the wearing state, the earlobe front attaching portion cooperates with the ear back fitting portion to from a clamping space to clamp the user's earlobe.

According to an embodiment, the earlobe connecting portion comprises an earlobe front attaching portion and an earlobe back attaching portion integrally connected to the earlobe front attaching portion, and when the acoustic earring is in the wearing state, the earlobe front attaching portion is extended from a front surface of the user's earlobe to a back surface thereof, so as to be connected to the ear back fitting portion.

According to an embodiment, the earlobe-surrounding connecting earring portion comprise a set of wires and has a wire groove, wherein the wire groove is communicated with the storage cavity and the installation cavity, and the circuit board is electrically connected to the speaker through the wires disposed in the wire groove.

According to an embodiment, the earlobe-surrounding connecting earring portion comprise a set of wires and has a wire groove which is indented along a front surface of the earlobe-surrounding connecting earring portion, and communicated with the storage cavity and the installation cavity, and when the acoustic earring is in the wearing state, the wires disposed in the wire groove is exposed on a front side of the user's earlobe.

According to an embodiment, the acoustic earring comprises a decoration unit which is provided on at least one portion of the ear-hanging acoustic effect portion, the earlobe-surrounding connecting earring portion, and the ear back fitting portion.

According to an embodiment, the acoustic earring comprises an ear decorative element which is provided on a front surface of the earlobe-surrounding connecting earring portion.

According to an embodiment, the acoustic earring comprises an ear decorative element which is provided on a back surface of the earlobe-surrounding connecting earring portion.

According to an embodiment, the ear back fitting portion comprises a smart module which is integrated on the circuit board and electrically connected to the circuit board.

According to an embodiment, the ear back fitting portion comprises a hearing-aid unit which is integrated on the circuit board and electrically connected to the circuit boar.

### BRIEF DESCRIPTION OF THE DRAWINGS

FIG. 1 is a perspective view illustrating an overall structure of an acoustic earring according to a first preferred embodiment of the present invention.

FIG. 2 is another perspective view illustrating the overall structure of the acoustic earring according to the first preferred embodiment of the present invention.

FIG. 3 is another perspective view illustrating the overall structure of the acoustic earring according to the first preferred embodiment of the present invention.

FIG. 4 is an exploded view of the acoustic earring according to the first preferred embodiment of the present invention

FIG. 5 is a perspective view illustrating the acoustic earring in a wearing scene according to the first preferred embodiment of the present invention.

FIG. 6 is a perspective view illustrating an overall structure of an acoustic earring according to a second preferred embodiment of the present invention.

FIG. 7 is an exploded view of the acoustic earring according to the second preferred embodiment of the present invention.

FIG. 8 is a perspective view illustrating an overall structure of an acoustic earring according to a third preferred embodiment of the present invention.

FIG. 9 is a perspective view illustrating an overall structure of an acoustic earring according to a fourth preferred embodiment of the present invention.

FIG. 10 is a perspective view illustrating an overall structure of an acoustic earring according to a fifth preferred embodiment of the present invention.

FIG. 11 is an exploded view of the acoustic earring according to the fifth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

It can be understood that the term “a” or “an” should be understood as “at least one” or “one or more”, that is, in one embodiment, the quantity of a component can be one, while in another embodiment, the quantity of the component can be multiple. The term “a” or “an” should not be understood as a limitation on the quantity.

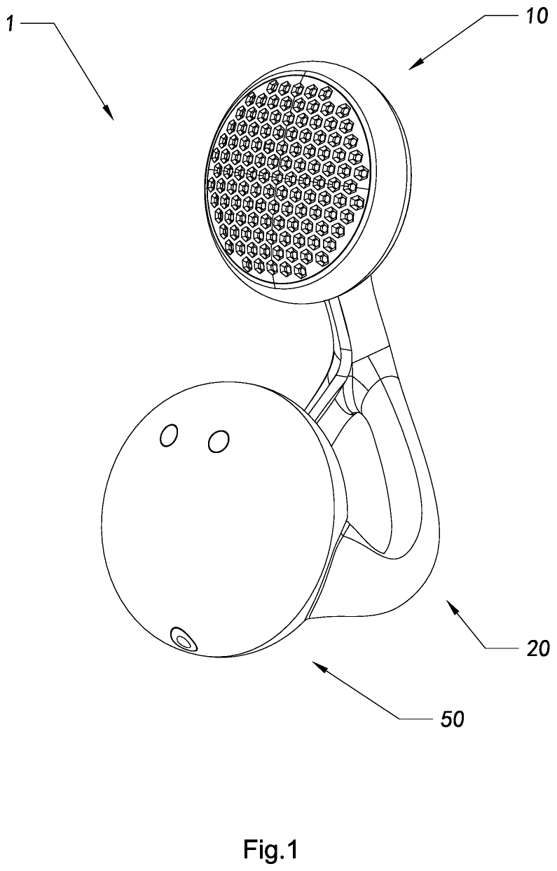

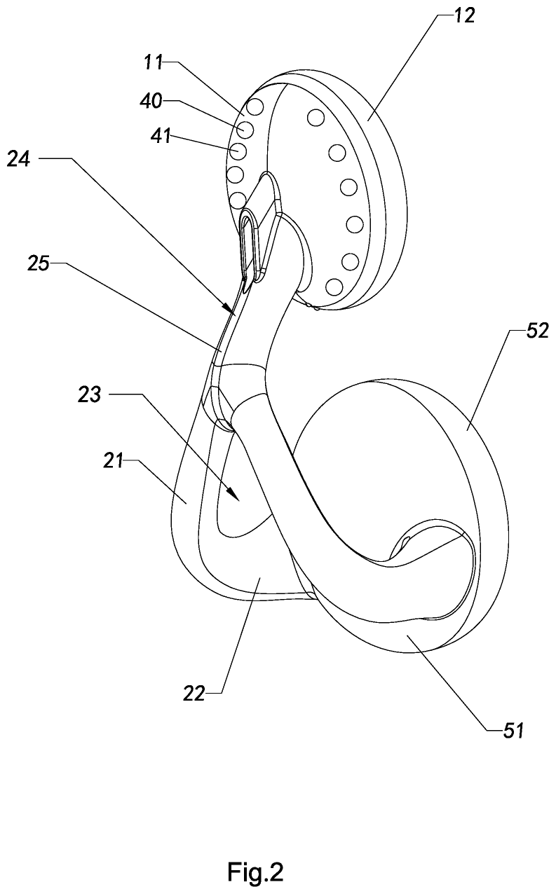

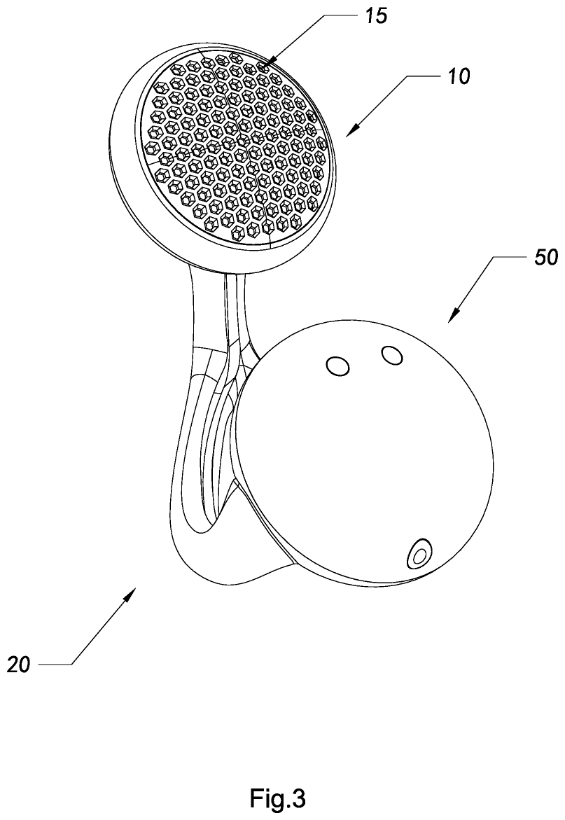

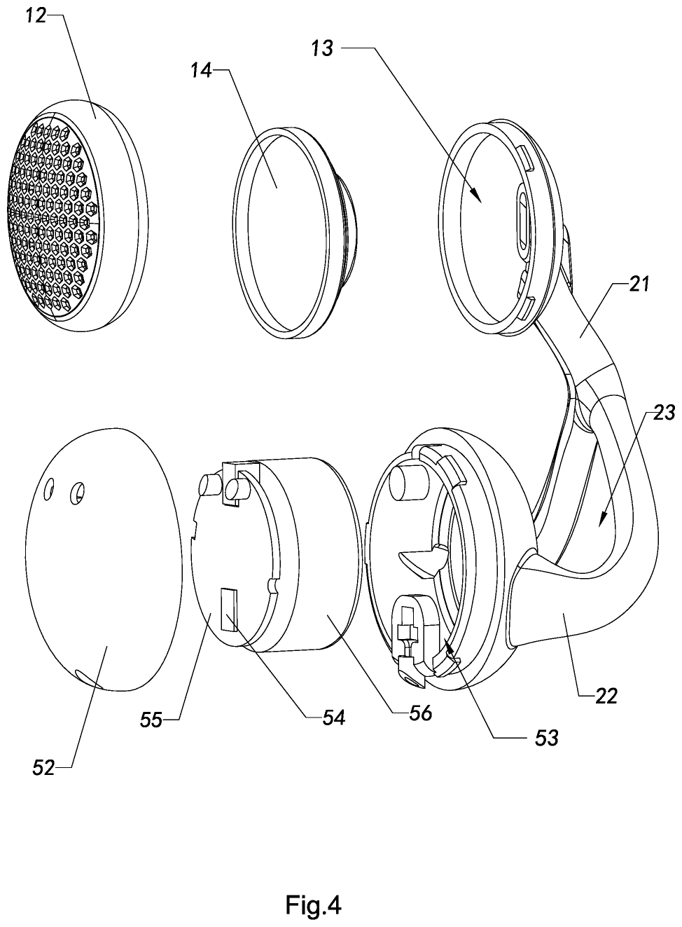

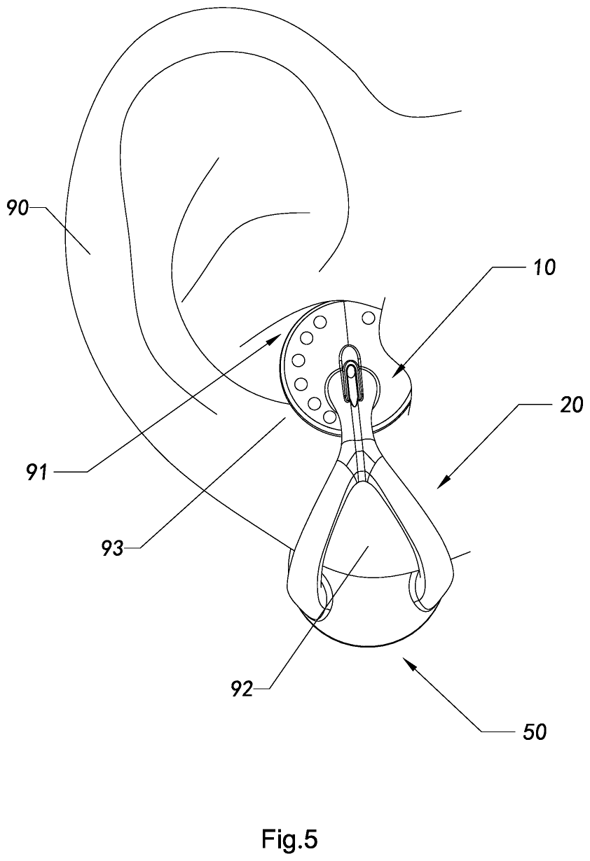

As shown in FIGS. 1 to 5, an acoustic earring 1 according to a first preferred embodiment of the present invention is illustrated. The acoustic earring 1 is designed to be worn on the user's ear 90 and outputs sound to the user's ear canal through an electroacoustic conversion.

For ease of explanation, when the acoustic earring 1 is worn by the user, a front side of the user's earlobe 92 is defined as the front, and a back side of the user's earlobe 92 is defined as the back. The side which is similar to the user's cavum conchae 91 located above the user's earlobe 92 is defined as the top, and vice versa, defined as the bottom.

The acoustic earring 1 comprises an ear-hanging acoustic effect portion 10, an earlobe-surrounding connecting earring portion 20, and an ear back fitting portion 50. The ear-hanging acoustic effect portion 10, the earlobe-surrounding connecting earring portion 20, and the ear back fitting portion 50 are interconnected. One end of the earlobe-surrounding connecting earring portion 20 is connected to the ear-hanging acoustic effect portion 10, and the other end thereof is connected to the ear back fitting portion 50. When the acoustic earring 1 is worn, the ear-hanging acoustic effect portion 10 is located inside the user's cavum conchae 91, the earlobe-surrounding connecting earring portion 20 surrounds the user's earlobe 92, extending from a front surface of the user's earlobe 92 to a back surface of the earlobe 92, and the ear back fitting portion 50 is located at a back surface of the user's earlobe 92. The ear-hanging acoustic effect portion 10 is located above the ear back fitting portion 50 and interconnected through the earlobe-surrounding connecting earring portion 20. The earlobe-surrounding connecting earring portion 20 fits on the user's earlobe 92 during the wearing process to meet different user wearing needs and looks like a decorative earring.

The ear-hanging acoustic effect portion 10 has the function of sound output. The earlobe-surrounding connecting earring portion 20 has the function of connection and installation fixation. The ear back fitting portion 50 has additional functions, or example, power supply, artificial intelligent interaction, etc. Compared to conventional earphones, the ear-hanging acoustic effect portion 10 of the acoustic earring 1 is hung in the user's cavum conchae 91 and adjacent to the position of an antitragus 93, and the earlobe-surrounding connecting earring portion 20 and the ear back fitting portion 50 are clamped on the user's earlobe 92 to achieve the positioning and fixation of the acoustic earring 1 and make the ear-hanging acoustic effect portion 10 tend to outwardly press against the antitragus, so that it does not completely seal off the user's ear canal and does not form a closed space between the eardrum and the ear-hanging acoustic effect portion 10, avoiding the insertion wearing method, and avoiding damage to the user's eardrum and hearing disorder caused by long-term wearing.

When the acoustic earring 1 is in a wearing state, the ear-hanging acoustic effect portion 10 is located in the user's cavum conchae 91. Compared to conventional earphones, the hanging position of the ear-hanging acoustic effect portion 10 is appropriate, protecting the user's privacy, and will not disturb others due to sound leakage while keeping the ear canal being communicated to the outside world, so that the user can hear environment noise and avoid safety hazards.

It is worth mentioning that the earlobe-surrounding connecting earring portion 20 can be made of a rigid material or preferably have a certain degree of flexibility or deformability. In this embodiment, the earlobe-surrounding connecting earring portion 20 plays a role in clamping the user's earlobe 92 during wearing. During the wearing process of the acoustic earring 1, the ear-hanging acoustic effect portion 10 is hung inside the user's cavum conchae 91, and is finally fixed and worn on the user's ear by the auxiliary clamping of the earlobe-surrounding connecting earring portion 20, so as to avoid the acoustic earring 1 to be lost caused by detachment. And subsequently, the ear back fitting portion 50 can be moved away from the back of the user's earlobe 92 by the flexibility of the earlobe-surrounding connecting earring portion 20, allowing the acoustic earring 1 to be easily removed.

Compared to the centralized distribution structure of various functions in conventional earphones, the acoustic earring 1 separates the functions of the ear-hanging acoustic effect portion 10 and the ear back fitting portion 50 from each other, achieves a larger size of the sound effect component located in the user's cavum conchae 91, maximize the sound effect output, and provide the user with a better using experience. Moreover, the separation of the ear back fitting portion 50 avoids the centralized implementation of the corresponding functions. During wearing, the ear back fitting portion 50 is located on the back of the user's earlobe 92, without being limited by the space size of the user's cavum conchae 91. In terms of manufacturing process, compared to conventional earphones, the ear back fitting portion 50 can be improved with a larger battery capacity to achieve longer battery life.

Furthermore, the acoustic earring 1 comprises an decoration unit 40. In this embodiment, the decoration unit 40 is located on the front end surface of the ear-hanging acoustic effect portion 10. Specifically, the decoration unit 40 comprises a plurality of decoration elements 41 each is implemented as a diamond, jewelry or other decorative item in this embodiment. In another embodiment, the decoration unit 40 can be set on the earlobe-surrounding connecting earring portion 20 or the ear back fitting portion 50. Therefore, the positioning of the decoration unit 40 is not limited by the present invention.

The decoration unit 40 can cooperate with the moldability of the earlobe-surrounding connecting earring portion 20 to achieve a decorative effect for the acoustic earring 1. In other words, the decoration unit 40 and the earlobe-surrounding connecting earring portion 20 together achieve the decorative purpose of the acoustic earring 1. The decoration unit 40 and the earlobe-surrounding connecting earring portion 20 provide a certain aesthetic appearance.

The ear-hanging acoustic effect portion 10 comprises a first installation element 11. a first cover body 12, and has a storage cavity 13. The first installation element 11 is integrally connected to the earlobe-surrounding connecting earring portion 20. The first cover body 12 is installed at the rear side of the first installation element 11. In the manufacturing process, the first installation element 11 can be detachably connected to the first cover body 12. The material of the first installation element 11 is the same as the material of the earlobe-surrounding connecting earring portion 20. The material of the first cover body 12 can be different from the material of the first installation element 11. When the first cover body 12 is installed on the first installation element 11, the first cover body 12 and the first installation element 11 provide a mounting space for the sound generating functional component.

Furthermore, the material of the first installation element 11 is preferably selected as a deformable material such as copper in this embodiment. The material of the first installation element 11 also can be silver, stainless steel, precious metals such as K gold, pure gold, etc. The material can also be ABS material, PP material, PC material, rubber, silicone, and other materials. The material can be elastic or rigid. Therefore, the material of the first installation element 11 is not limited by the present invention. In this embodiment, the decoration unit 40 is arranged on the first installation element 11. When the acoustic earring 1 is worn, the first installation element 11 faces the front of the user, and the decoration unit 40 faces the front, adding a certain decorative effect.

The material of the first cover body 11 is different from the material of the first installation element 11. When the acoustic earring 1 is worn, the first cover body 11 faces the ear canal of the user. The material of the first cover body 11 is made of a material that does not block the sound from transmitting out, thus the first cover body 11 does not affect the sound output.

The ear-hanging acoustic effect portion 10 comprises a speaker 14. The speaker 14 is adapted for providing electro-acoustic conversion, amplifying and outputting the converted sound source. In other words, the acoustic earring 1 realizes the sound output to the user through the speaker 14. The speaker 14 is suitable for being installed in the storage cavity 13. In other words, the speaker 14 is installed between the first installation element 11 and the first cover body 12. When the acoustic earring 1 is worn, the speaker 14 faces the user's ear canal and outputs sound to the user's ear canal through the first cover body 12.

The ear-hanging acoustic effect portion 10 has a plurality of noise reduction holes 15 formed in the first cover body 12. The noise reduction holes 15 have the function of noise reduction. When the acoustic earring 1 is worn, the noise reduction holes 15 face the user's ear canal. The noise reduction holes 15 penetrate through the first cover body 12. The speaker 14 outputs sound to the user's ear canal through the noise reduction holes 15, and noise reduction processing is performed through the noise reduction holes 15.

Correspondingly, the ear back fitting portion 50 comprises a second installation element 51, a second cover body 52, and has an installation cavity 53. The second installation element 51 is integrally connected to the earlobe-surrounding connecting earring portion 20, and the second cover body 52 is connected to the second installation element 51. The second installation element 51 and the second cover body 52 have different materials. The installation cavity 53 is located between the second installation element 51 and the second cover body 52. When the acoustic earring 1 is worn, the second installation element 51 fits tightly against the back side of the user's earlobe 92, and the second cover body 52 is arranged at a side away from the user's earlobe 92. The installation cavity 53 is suitable for receiving various functional components to achieve power supply, intelligent interaction, and other purposes.

The earlobe-surrounding connecting earring portion 20 comprises an earlobe front attaching portion 21, an earlobe back attaching portion 22, and has a clamping space 23. The earlobe front attaching portion 21 is integrally connected to the earlobe back attaching portion 22. The earlobe front attaching portion 21 is integrally connected to the first installation element 11, and the earlobe back attaching portion 22 is integrally connected to the second installation element 51. Therefore, the first installation element 11, the second installation element 51, the earlobe front attaching portion 21, and the earlobe back attaching portion 22 are made of the same material. In this embodiment, the earlobe front attaching portion 21 and the earlobe back attaching portion 22 are arranged in a “J” shape. A clamping space 23 is formed between the earlobe front attaching portion 21 and the earlobe back attaching portion 22. The clamping space 23 is suitable for clamping the user's earlobe 92. In other words, when the acoustic earring 1 is worn, the rear side of the earlobe front attaching portion 21 is in close contact with the front surface of the user's earlobe 92, and the front surface of the earlobe back attaching portion 22 is in close contact with the rear surface of the user's earlobe 92. The user's earlobe 92 is always located within the clamping space 23.

Next, due to the flexibility and deformability of the earlobe-surrounding connecting earring portion 20, the earlobe front attaching portion 21 and the earlobe back attaching portion 22 can be flexibly moved with respect to each other to change the spatial size of the clamping space 23. By changing the spatial size of the clamping space 23, it can fit earlobe sizes of different users. And by changing the real-time distance between the earlobe front attaching portion 21 and the earlobe back attaching portion 22 and the user's earlobe 92, the secure installation of the acoustic earring 1 can be achieved. The flexibility and deformability of the earlobe front attaching portion 21 and the earlobe back attaching portion 22 increases the range of applicable users and reduces the possibility of the acoustic earring 1 falling off when worn.

In this embodiment, the earlobe front attaching portion 21 is configured in an inverted “Y” shape. When the acoustic earring 1 is worn, the earlobe front attaching portion 21 is close to and attached to the user's earlobe 92. By the shape of the earlobe front attaching portion 21, the decorative function of the acoustic earring 1 is displayed forwardly, that is, the aesthetic appearance of the acoustic earring 1 is increased by the shape of the earlobe front attaching portion 21. In the manufacturing process, personal customization can be achieved by changing the different shapes of the earlobe front attaching portion 21, and the acoustic earring 1 with the preferred shape can be selected according to the user's preference to achieve the effect of wearing and matching, which is fashionable. Therefore, the shape of the earlobe front attaching portion 21 is not limited by the present invention.

The earlobe-surrounding connecting earring portion 20 also has at least one wire groove 24 and a set of wires 25. A wire groove 24 is set between the earlobe front attaching portion 21 and the earlobe back attaching portion 22. In other words, the wire groove 24 extends from an end of the earlobe front attaching portion 21 to an end of the earlobe back attaching portion 22. In this embodiment, there is one wire groove 24, and the wire groove 24 is set on the back side of the earlobe-surrounding connecting earring portion 20. In other words, the wire groove 24 is set on the rear surface of the earlobe front attaching portion 21 and the earlobe back attaching portion 22. The wire groove 24 is communicated to the storage cavity 13 and the installation cavity 53. The wire groove 24 is suitable for placing the set of wires 25 which is electrically connecting electrical components of the ear-hanging acoustic effect portion 10 and the ear back fitting portion 50. The wire groove 24 provides the function of routing, that is, the storage cavity 13 is communicated to the installation cavity 53 through the wire groove 24. In another embodiment of the present invention, the wire groove 24 is formed inside the earlobe-surrounding connecting earring portion 20, that is, the routing is done internally. Therefore, the setting of the wire groove 24 is not limited by the present invention.

In other embodiment, the wire groove 24 is implemented to be embedded with a transparent light strip which comprises an optical fiber and a light emitting element provided at an end of the wire groove 24. The transparent light strip is routed through the wire groove 24 and displayed externally to provide an enhanced decorative effect. Users can choose personalized colors for the transparent light strip according to their preferences to meet personalized fashion needs. In particular, when the acoustic earring 1 is worn at night, the transparent light strip in the wire groove 24 can emit different colors of light sources, which is very cool.

The ear back fitting portion 50 comprises a power supply 56 and a circuit board 55, and the power supply 56 and the circuit board 55 are installed in the installation cavity 53. The power supply 56 provides the function of supplying electrical energy. The circuit board 55 provides the function of processing electrical signals. The circuit board 55 receives and process electrical signals and sends to the speaker 14. The power supply 56 is electrically connected to the circuit board 55. The circuit board 55 is electrically connected to the speaker 14. The storage cavity 13 is communicated to the installation cavity 53 through the wire groove 24. The speaker 14 is electrically connected to the power supply 56 through the wires 25. It can be understood that in other alternative embodiments, at least one of the power supply 56 and the circuit board 55 can also be disposed in the ear-hanging acoustic effect portion 10.

It is worth mentioning that the acoustic earring 1 has the function of improving the user's mood. When the acoustic earring 1 is worn, it is suitable for monitoring the user's mood values such as heart rate through a light sensor, and then playing preset music or imitating sounds to adjust and improve the user's depressed mood. The circuit board 55 receives and processes electrical signals, delivers specified song signals to the speaker 14, and finally plays and delivers sound effects to the user through the speaker 14. The circuit board 55 is suitable for electrical connection to an external smart device. For parents, they can monitor their children's situation by connecting the acoustic earring 1 to the smart device's APP, so as to intervene in a timely manner and prevent unwanted things from happening.

The speaker 14 is disposed in the storage cavity 13, and the circuit board 55 and the power supply 56 are received in the installation cavity 53. The acoustic earring 1 separates the functions of the ear-hanging acoustic effect portion 10 and the ear back fitting portion 50 from each other. Compared to conventional integrated earphones, the acoustic earring 1 with a split structure has more advantages. For example, when the acoustic earring 1 is worn, the ear-hanging acoustic effect portion 10 is located in the user's cavum conchae 91, and the ear back fitting portion 50 is located at the back of the user's earlobe 92. The ear-hanging acoustic effect portion 10 occupies a larger space in the user's cavum conchae 91. In terms of manufacturing process, for the ear-hanging acoustic effect portion 10 close to the user's ear canal, the size of its speaker 14 can be increased to output better sound quality.

Additionally, the ear back fitting portion 50 located at the back of the user's earlobe 92 only occupies the space of the user's earlobe 92, making the space occupied by the ear back fitting portion 50 also larger. In terms of manufacturing process, by increasing the overall volume of the ear back fitting portion 50, the installation cavity 53 can be enlarged, and the size of the power supply 56 can be correspondingly increased. By changing the size of the installation cavity 53 to accommodate the increased capacity of the power supply 56, the battery life of the acoustic earring 1 can be increased, thereby extending the applicable time of the acoustic earring 1.

The ear back fitting portion 50 further comprises a smart module 54 which is disposed in the installation cavity 53. The smart module 54 is capable of providing voice reminders, wake-up functions, etc., and serves as an access port of the internet of things. Furthermore, the smart module 54, which is integrated on the circuit board 55, is capable of receiving and processing information, transmitting the processed information to the circuit board 55, and ultimately delivering it to the speaker 14 for corresponding operations. In this embodiment, the smart module 54 obtains instructions in real time through human voice, recognizes and processes collected information, provides feedback based on semantic results, and ultimately performs tasks such as measuring body temperature and checking heart rate. It can also be used for intelligent interaction scenarios in various life and work situations, such as controlling smart home appliances, smart office devices, intelligent calls, smart driving, and smart medical care.

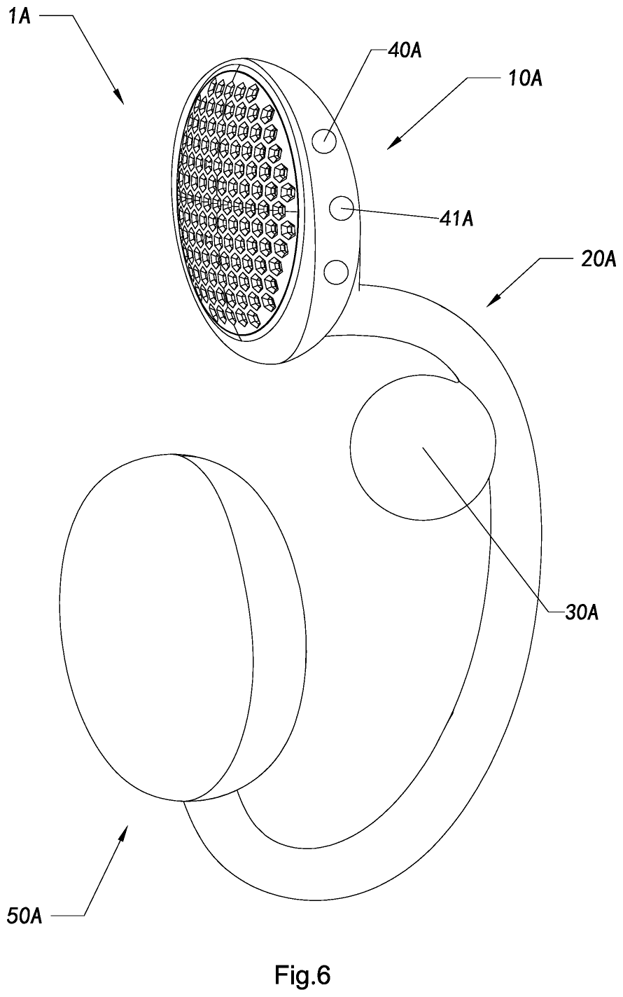

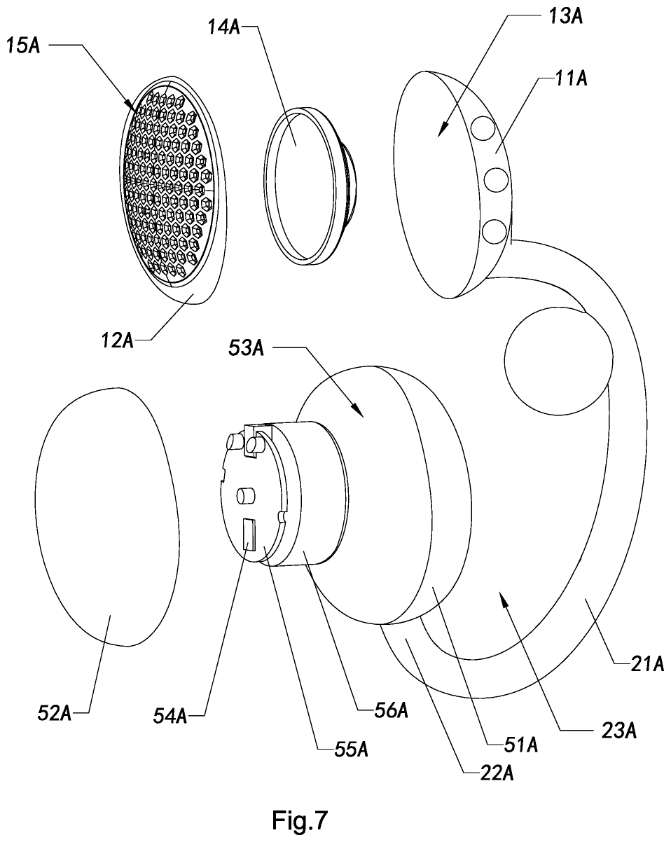

FIGS. 6 and 7 illustrate an acoustic earring 1A according to a second preferred embodiment of the present invention. Compared to the previous first embodiment, when the acoustic earring 1A is worn on the user's ear, there are changes in the decorative aspect at the user's earlobe 92, as well as additional decorations on the earphone itself.

The acoustic earring 1A comprises an ear-hanging acoustic effect portion 10A, an earlobe-surrounding connecting earring portion 20A, and an ear back fitting portion 50A. The ear-hanging acoustic effect portion 10A, the earlobe-surrounding connecting earring portion 20A, and the ear back fitting portion 50A are interconnected. One end of the earlobe-surrounding connecting earring portion 20A is connected to the ear-hanging acoustic effect portion 10A, and the other end is connected to the ear back fitting portion 50A. When the acoustic earring 1A is worn, the ear-hanging acoustic effect portion 10A is located inside the user's cavum conchae 91, the earlobe-surrounding connecting earring portion 20A surrounds the user's earlobe 92, extending from the front surface of the user's earlobe 92 to the back surface of the earlobe 92, and the ear back fitting portion 50A is located at the back surface of the user's earlobe 92. The ear-hanging acoustic effect portion 10A has the function of sound output. The earlobe-surrounding connecting earring portion 20A has the function of connection and installation fixation and looks like a decorative earring. The ear back fitting portion 50A has additional functions such as power supply and artificial intelligent interaction.

Furthermore, the acoustic earring 1A comprises a decoration unit 40A. In this embodiment, the decoration unit 40A is located on the front surface of the ear-hanging acoustic effect portion 10A. Specifically, the decoration unit 40A is arranged on the front surface of the ear-hanging acoustic effect portion 10A. In this embodiment, each of the decoration elements 41A of the decoration unit 40A is implemented as a diamond or other decorative items.

It is worth mentioning that the acoustic earring 1A further comprises an ear decorative element 30A. In this embodiment, the ear decorative element 30A is implemented as a pearl, diamond, or crystal. In another embodiment, the ear decorative element 30A can be implemented as any item that serves a decorative purpose, and is not limited by the present invention. The ear decorative element 30A is provided on the back of the earlobe-surrounding connecting earring portion 20A. When the acoustic earring 1A is worn, the ear decorative element 30A is clamped between the earlobe-surrounding connecting earring portion 20A and the user's earlobe 92. In appearance, the ear decorative element 30A is precisely placed on the user's earlobe 92, serving a certain decorative purpose. In other words, when the acoustic earring 1A is worn, it plays a role in decorating the earlobe 92 and has aesthetic appearance.

The ear-hanging acoustic effect portion 10A comprises a first installation element 11A, a first cover body 12A, and has a storage cavity 13A. The first installation element 11A is integrally connected to the earlobe-surrounding connecting earring portion 20A. The first cover body 12A is installed at the rear side of the first installation element 11A. When the first cover body 12A is installed on the first installation element 11A, the storage cavity 13A is formed between the first cover body 12A and the first installation element 11A. The storage cavity 13A is suitable for providing an installation space for audio function components.

The ear-hanging acoustic effect portion 10A comprises a speaker 14A. The speaker 14A is adapted to provide electroacoustic conversion, amplify and output the converted sound. The speaker 14A is adapted to be installed in the storage cavity 13A. The ear-hanging acoustic effect portion 10A has a plurality of noise reduction holes 15A which is formed in the first cover body 12A. The noise reduction holes 15A have the function of noise reduction, and when the acoustic earring 1 is worn, the noise reduction holes 15A face the user's ear canal.

Correspondingly, the ear back fitting portion 50A comprises a second installation element 51A, a second cover body 52A, and has an installation cavity 53A. The first installation element 51A is integrally connected to the earlobe-surrounding connecting earring portion 20A, and the second cover body 52A is connected to the second installation element 51A. The installation cavity 53A is located between the second installation element 51A and the second cover body 52A. The installation cavity 53A is suitable for receiving various functional components to achieve power supply, intelligent interaction, and other purposes.

The ear back fitting portion 50A comprises a power supply 56A and a circuit board 55A, and the power supply 56A and the circuit board 55A are installed in the installation cavity 53A. The power supply 56A provides the function of supplying power. The circuit board 55A provides the function of processing electrical signals. The circuit board 55A receives and processes electrical signals and then drives the speaker 14A to generating sound. The power supply 56A is electrically connected to the circuit board 55A. The circuit board 55A is electrically connected to the speaker 14A. The ear back fitting portion 50A also comprises a smart module 54A, which is disposed in the installation cavity 53A. The smart module 54A is capable of providing functions such as voice reminding and wake-up calling, and serves as an access port of the internet of things. Furthermore, the smart module 54A can be integrated on the circuit board 55A.

The earlobe-surrounding connecting earring portion 20A comprises an earlobe front attaching portion 21A, an earlobe back attaching portion 22A, and has a clamping space 23A. The earlobe front attaching portion 21A is integrally connected to the earlobe back attaching portion 22A. The earlobe front attaching portion 21A is integrally connected to the first installation element 11A, and the earlobe back attaching portion 22A is integrally connected to the second installation element 51A. The clamping space 23A is formed between the earlobe front attaching portion 21A and the earlobe back attaching portion 22A, and the clamping space 23A is suitable for accommodating the user's earlobe 92. In this embodiment, the ear decorative element 30A is installed at a back side of the earlobe front attaching portion 21A. When the acoustic earring 1A is worn, the car decorative element 30A is located between the user's earlobe 92 and the earlobe front attaching portion 21A. In front of the user, it can be decorated on the user's earlobe 92, playing a decorative role.

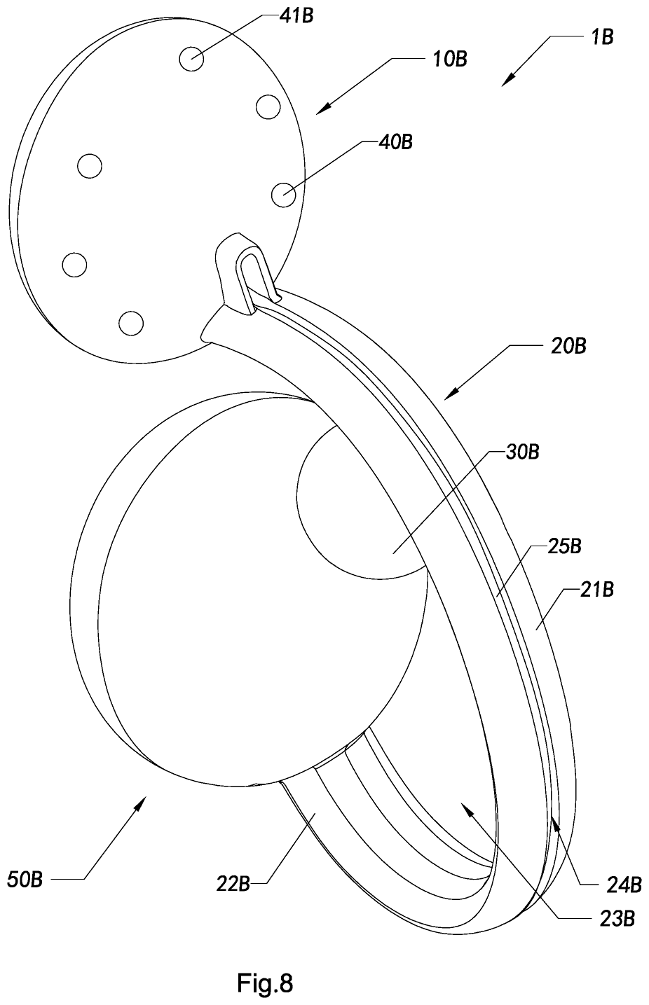

FIG. 8 is a perspective view of an acoustic earring 1B according to a third preferred embodiment of the present invention is illustrated. Compared with the above-mentioned embodiments, the acoustic earring 1B has certain advantages in the manufacturing process, adding a certain advantage to the wiring of electrical components.

The acoustic earring 1B comprises an ear-hanging acoustic effect portion 10B, an earlobe-surrounding connecting earring portion 20B, and an ear back fitting portion 50B. The ear-hanging acoustic effect portion 10B, the earlobe-surrounding connecting earring portion 20B, and the ear back fitting portion 50B are interconnected. One end of the earlobe-surrounding connecting earring portion 20B is connected to the ear-hanging acoustic effect portion 10B, and the other end thereof is connected to the ear back fitting portion 50B. When the acoustic earring 1B is worn, the ear-hanging acoustic effect portion 10B is located inside the user's cavum conchae 91, the earlobe-surrounding connecting earring portion 20B surrounds the user's earlobe 92, extending from the front surface of the user's earlobe 92 to the back surface of the earlobe 92, and the ear back fitting portion 50B is located at the back surface of the user's earlobe 92. The ear-hanging acoustic effect portion 10B has the function of sound output. The earlobe-surrounding connecting earring portion 20B has the function of connection and installation fixation, and also has an earring appearance. The ear back fitting portion 50B has additional functions such as power supply, artificial intelligent interaction.

The acoustic earring 1B further comprises at least one ear decorative element 30B and at least one decoration unit 40B. The ear decorative element 30B is provided on the back surface of the earlobe-surrounding connecting earring portion 20B, and the decoration unit 40B is formed on the front surface of the ear-hanging acoustic effect portion 10B.

The earlobe-surrounding connecting earring portion 20B comprises an earlobe front attaching portion 21B, an earlobe back attaching portion 22B, and has a clamping space 23B. The earlobe front attaching portion 21B is integrally connected to the earlobe back attaching portion 22B. The earlobe front attaching portion 21B is integrally connected to the ear-hanging acoustic effect portion 10B, and the earlobe back attaching portion 22B is integrally connected to the ear back fitting portion 50B. The clamping space 23B is formed between the earlobe front attaching portion 21B and the earlobe back attaching portion 22B, and the clamping space 23B is suitable for accommodating the user's earlobe 92.

In this embodiment, the earlobe-surrounding connecting earring portion 20B also has a wire groove 24B, and the wire groove 24B is extended along a front surface of the earlobe front attaching portion 21B. In other words, the wire groove 24B extends from an end of the front surface of the earlobe front attaching portion 21B to an end of the earlobe back attaching portion 22B. The wire groove 24B, which is communicated with the cavities of the ear-hanging acoustic effect portion 10B and the ear back fitting portion 50B, provides the function of routing the wires 25B.

Specifically, the wire groove 24B is oriented towards the front of the acoustic earring 1B. When the acoustic earring 1B is worn, the wire groove 24B is oriented at a front side of the acoustic earring 1B. When the wires 25B passes through the wire groove 24B, the color of the wires 25B located inside the wire groove 24B can be exposed. In the manufacturing process, different colored wires 25B can be selectively chosen and ultimately exposed in the wire groove 24B to meet the user's preference. In other words, the user can select the personalized color of the wires 25B exposed in the wire groove 24B based on their own color preference. The wire groove 24B can be combined with patterns, carvings, and other decorative elements provided on the earlobe front attaching portion 21B to increase the level of decoration.

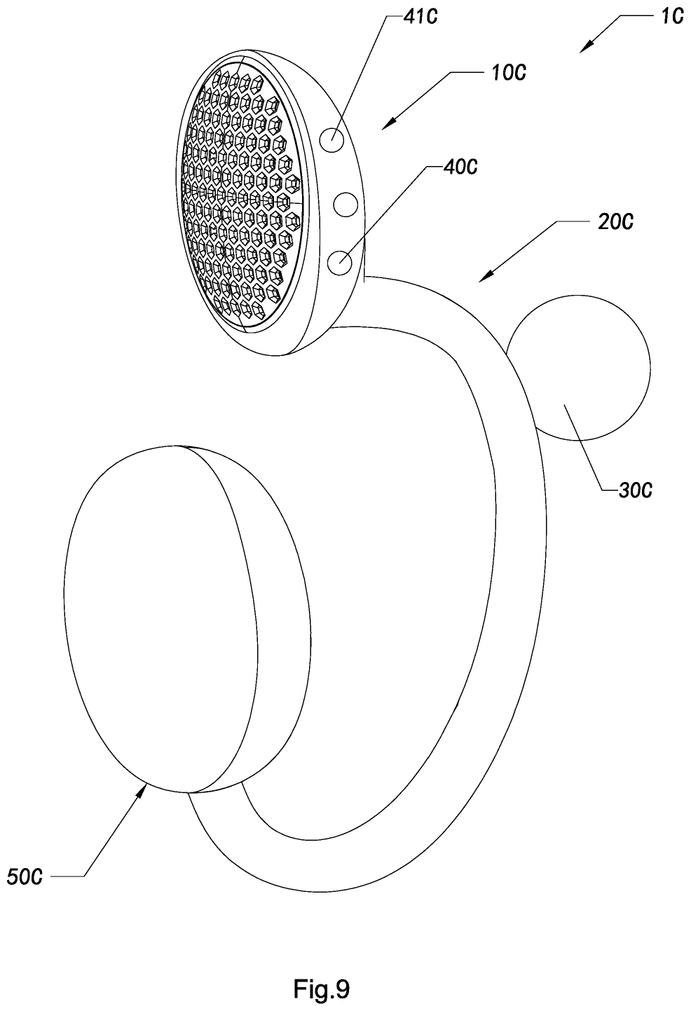

FIG. 9 is a perspective view of an acoustic earring 1C according to a fourth preferred embodiment of the present invention. Compared to the above embodiments, the position of the component that serves a decorative function of the acoustic earring 1C has changed.

The acoustic earring 1C comprises an ear-hanging acoustic effect portion 10C, an earlobe-surrounding connecting earring portion 20C, and an ear back fitting portion 50C. The ear-hanging acoustic effect portion 10C, the earlobe-surrounding connecting earring portion 20C, and the ear back fitting portion 50C are interconnected. One end of the earlobe-surrounding connecting earring portion 20C is connected to the ear-hanging acoustic effect portion 10C, and the other end thereof is connected to the ear back fitting portion 50C. When the acoustic earring 1C is in a wearing state, the ear-hanging acoustic effect portion 10C is located inside the user's cavum conchae 91, the earlobe-surrounding connecting earring portion 20C is wrapped around the user's earlobe 92, extending from the front surface of the user's earlobe 92 to the back surface of the earlobe 92, and the ear back fitting portion 50C is located at the back surface of the user's earlobe 92. The ear-hanging acoustic effect portion 10C has the function of sound output. The earlobe-surrounding connecting earring portion 20C has the function of connection and installation fixation, as well as decoration like an earring. The ear back fitting portion 50C has additional functions such as power supply and artificial intelligent interaction.

The earlobe-surrounding connecting earring portion 20C comprises an earlobe front attaching portion 21C, an earlobe back attaching portion 22C, and has a clamping space 23C. The earlobe front attaching portion 21C is integrally connected to the earlobe back attaching portion 22C. The earlobe front attaching portion 21C is integrally connected to the ear-hanging acoustic effect portion 10C, and the earlobe back attaching portion 22C is integrally connected to the ear back fitting portion 50C. The clamping space 23C is formed between the earlobe front attaching portion 21C and the earlobe back attaching portion 22C, and the clamping space 23C is suitable for accommodating the user's earlobe 92.

The acoustic earring 1C further comprises at least one ear decorative element 30C and at least one decoration unit 40C. The ear decorative element 30C is provided on a front surface of the earlobe-surrounding connecting earring portion 20C, and the decoration unit 40C is provided on a front surface of the ear-hanging acoustic effect portion 10C. When the acoustic earring 1C is worn, the ear decorative element 30C is positioned at the user's earlobe 92, replacing the current decorations such as earrings, and serves a decorative purpose.

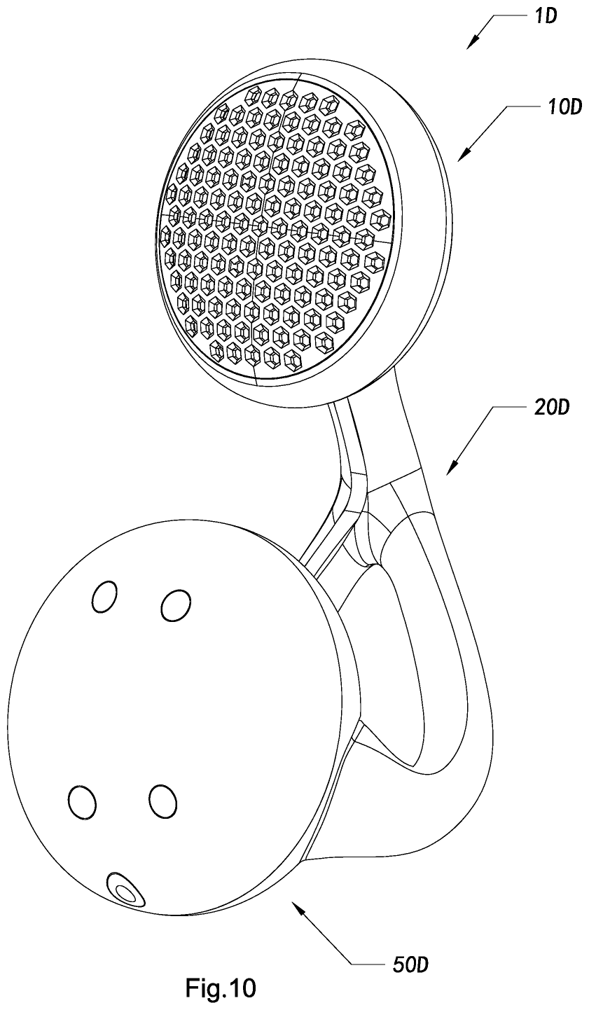

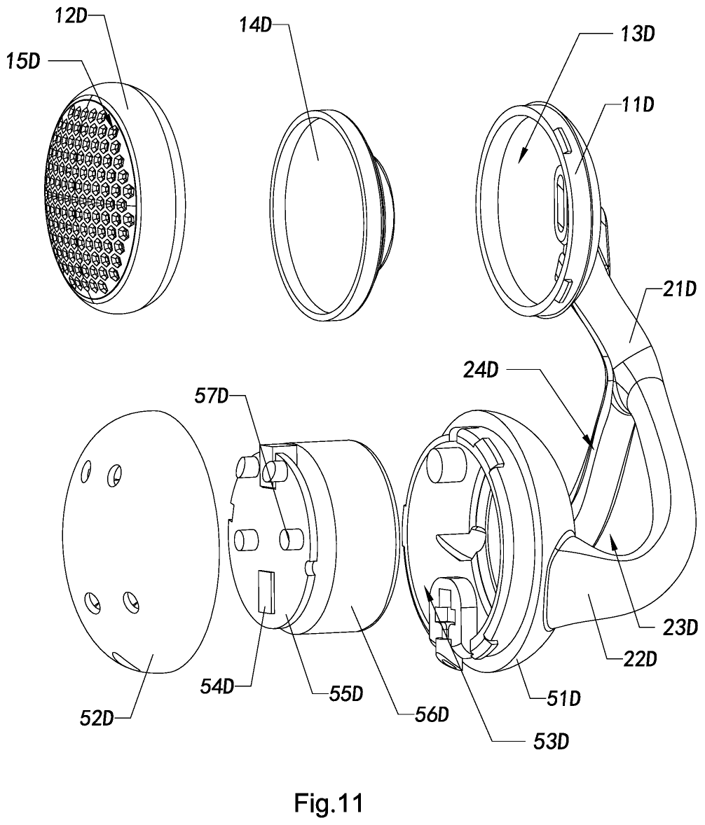

FIGS. 10 and 11 of the drawings illustrate an acoustic earring 1D according to a fifth preferred embodiment of the present invention. In this embodiment, changes have been made in terms of functionality compared to the above embodiments.

The acoustic earring 1D comprises an ear-hanging acoustic effect portion 10D, an earlobe-surrounding connecting earring portion 20D, and an ear back fitting portion 50D. The ear-hanging acoustic effect portion 10D, the earlobe-surrounding connecting earring portion 20D, and the ear back fitting portion 50D are interconnected. One end of the earlobe-surrounding connecting earring portion 20D is connected to the ear-hanging acoustic effect portion 10D, and the other end thereof is connected to the ear back fitting portion 50D. When the acoustic earring 1D is worn, the ear-hanging acoustic effect portion 10D is located inside the user's cavum conchae 91, the earlobe-surrounding connecting earring portion 20D surrounds the user's earlobe 92, extending from the front surface of the user's earlobe 92 to the back surface of the earlobe 92, and the ear back fitting portion 50D is located at the back surface of the user's earlobe 92. The ear-hanging acoustic effect portion 10D has the function of sound output. The earlobe-surrounding connecting earring portion 20D has the function of connection and installation fixation, as well as decoration like an earring. The ear back fitting portion 50D has additional functions such as power supply and artificial intelligent interaction.

The ear-hanging acoustic effect portion 10D comprises a first installation element 11D, a first cover body 12D, and has a storage cavity 13D. The first installation element 11D is integrally connected to the earlobe-surrounding connecting earring portion 20D. The first cover body 12D is installed at the rear side of the first installation element 11D. When the first cover body 12D is installed on the first installation element 11D, a storage cavity 13D is formed between the first cover body 12D and the first installation element 11D. The storage cavity 13D is suitable for providing installation space for audio function components.

The ear-hanging acoustic effect portion 10D comprises a speaker 14D. The speaker 14D is suitable for providing electro-acoustic conversion, amplifying and outputting the converted sound. The speaker 14D is suitable for being installed inside the storage cavity 13D. The ear-hanging acoustic effect portion 10D has a plurality of noise reduction holes 15D formed in the first cover body 12D for noise reduction. When the acoustic earring 1D is worn, the noise reduction holes 15D face towards the user's ear canal.

The earlobe-surrounding connecting earring portion 20D comprises an earlobe front attaching portion 21D, an earlobe back attaching portion 22D, and has a clamping space 23D. The earlobe front attaching portion 21D is integrally connected to the earlobe back attaching portion 22D. The earlobe front attaching portion 21D is integrally connected to the ear-hanging acoustic effect portion 10D, and the earlobe back attaching portion 22D is integrally connected to the ear back fitting portion 50D. The clamping space 23D is formed between the earlobe front attaching portion 21D and the earlobe back attaching portion 22D, and the clamping space 23D is suitable for accommodating the user's earlobe 92. The earlobe-surrounding connecting earring portion 20D also has a wire groove 24D, which is indented and extended along a front surface of the earlobe front attaching portion 21D.

The ear back fitting portion 50D comprises a second installation element 51D and a second cover body 52D, and has an installation cavity 53D. The first installation element 51D is integrally connected to the earlobe-surrounding connecting earring portion 20D. and the second cover body 52D is connected to the second installation element 51D. The installation cavity 53D is located between the second installation element 51D and the second cover body 52D. Various functional components can be set in the installation cavity 53D to achieve purposes such as power supply and intelligent interaction.

The ear back fitting portion 50D comprises a power supply 56D and a circuit board 55D, and the power supply 56D and the circuit board 55D are installed in the installation cavity 53D. The power supply 56D provides the function of supplying power. The circuit board 55D provides the function of processing electrical signals. The circuit board 55D receives and process electrical signals, and drives the speaker 14D to generate sound. The power supply 56D is electrically connected to the circuit board 55D. The circuit board 55D is electrically connected to the speaker 14D. The ear back fitting portion 50D further comprises a smart module 54D which is disposed in the installation cavity 53D. The smart module 54D is capable of providing functions such as voice reminding and wake-up calling, and the smart module 54D may serve as an access port of the internet of things. Furthermore, the smart module 54D can by integrated on the circuit board 55D.

The ear back fitting portion 50D further comprises a hearing-aid unit 57D which is integrated on the circuit board 55D and comprises structures such as microphone, amplifier, and receiver. The microphone is used to collect sound and convert it into electrical waves, the amplifier is used to increase the intensity of the electrical waves, and the receiver is used to convert the electrical energy back into sound waves. The hearing-aid unit 57D is electrically connected to the power supply 56D and the circuit board 55D. The acoustic earring 1D can freely switch between the scenarios of making and receiving calls and listening to people speaking through the hearing-aid unit 57D. When a call comes in, it can be connected to a smart device via Bluetooth, and the acoustic earring 1D switches to the function of making calls. The acoustic earring 1D can normally provide hearing assistance through the hearing-aid unit 57D, making it convenient for users with hearing impairments to wear. This avoids the inconvenience of alternating between wearing the acoustic earring 1D and hearing-aids. By integrating the hearing assistance function into the acoustic earring 1D, it can be used by a larger population, so as to expand its market scale and usage value.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and are subject to change without departure from such principles.

What is claimed is:

1. An acoustic earring, comprising:
an ear-hanging acoustic effect portion for being located at an inner side of a user's antitragus to generate sound effect;
an earlobe-surrounding connecting earring portion; and
an ear back fitting portion, said earlobe-surrounding connecting earring portion is connected between said ear-hanging acoustic effect portion and said ear back fitting portion.

2. The acoustic earring according to claim 1, wherein when said acoustic earring is in a wearing state, said ear-hanging acoustic effect portion is located inside the user's cavum conchae, and said earlobe-surrounding connecting earring portion is extended from a front side of the user's earlobe to a back side of the user's earlobe to position and locate said ear back fitting portion at a back side of the user's earlobe.

3. The acoustic earring according to claim 2, wherein said ear-hanging acoustic effect portion comprises a first installation element and a first cover body, and has a storage cavity, wherein said first installation element is integrally connected to said earlobe-surrounding connecting earring portion, and said first cover body is installed at a rear side of said first installation element, wherein said storage cavity is located between said first installation element and said second cover body.

4. The acoustic earring according to claim 3, wherein said ear back fitting portion comprises a second installation element, a second cover body, and has an installation cavity, wherein said second installation element is integrally connected to said earlobe-surrounding connecting earring portion, said second cover body is installed on a rear side of said second installation element, and said installation cavity is located between said second installation element and said second cover body.

5. The acoustic earring according to claim 4, wherein said earlobe-surrounding connecting earring portion, said first installation element, and said second installation element are integrated and made of same material.

6. The acoustic earring according to claim 4, wherein said ear-hanging acoustic effect portion comprises a speaker installed in said storage cavity and has a plurality of noise reduction holes formed in said first cover body.

7. The acoustic earring according to claim 6, wherein said ear back fitting portion comprises a circuit board and a power supply, wherein said circuit board and said power supply are installed in said installation cavity, and said circuit board and said power supply are electrically connected to each other.

8. The acoustic earring according to claim 7, wherein said earlobe-surrounding connecting earring portion comprises an earlobe front attaching portion and an earlobe back attaching portion integrally connected to said earlobe front attaching portion, wherein when said acoustic earring is in the wearing state, said earlobe front attaching portion cooperates with said ear back fitting portion to from a clamping space to clamp the user's earlobe.

9. The acoustic earring according to claim 7, wherein said earlobe connecting portion comprises an earlobe front attaching portion and an earlobe back attaching portion integrally connected to said earlobe front attaching portion, and when said acoustic earring is in the wearing state, said earlobe front attaching portion is extended from a front surface of the user's earlobe to a back surface thereof, so as to be connected to said ear back fitting portion.

10. The acoustic earring according to claim 7, wherein said earlobe-surrounding connecting earring portion comprise a set of wires and has a wire groove, wherein said wire groove is communicated with said storage cavity and said installation cavity, and said circuit board is electrically connected to said speaker through said wires disposed in said wire groove.

11. The acoustic earring according to claim 9, wherein said earlobe-surrounding connecting earring portion comprise a set of wires and has a wire groove which is indented along a front surface of said earlobe-surrounding connecting earring portion, and communicated with said storage cavity and said installation cavity, and when said acoustic earring is in the wearing state, said wires disposed in said wire groove is exposed on a front side of the user's earlobe.

12. The acoustic earring according to claim 1, wherein said acoustic earring comprises a decoration unit which is provided on at least one portion of said ear-hanging acoustic effect portion, said earlobe-surrounding connecting earring portion, and said ear back fitting portion.

13. The acoustic earring according to claim 12, wherein said acoustic earring comprises an ear decorative element which is provided on a front surface of said earlobe-surrounding connecting earring portion.

14. The acoustic earring according to claim 12, wherein said acoustic earring comprises an ear decorative element which is provided on a back surface of said earlobe-surrounding connecting earring portion.

15. The acoustic earring according to claim 7, wherein said ear back fitting portion comprises a smart module which is integrated on said circuit board and electrically connected to said circuit board.

16. The acoustic earring according to claim 7, wherein said ear back fitting portion comprises a hearing-aid unit which is integrated on said circuit board and electrically connected to said circuit board.
